(19) United States
(12) Patent Application Publication
(10) Pub. No.: US 2006/0136734 A1
(43) Pub. Date: Jun. 22, 2006

(54) Identification display device

(75) Inventors: Michael J. Telek, Pittsford, NY (US); Kurt M. Sanger, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/021,741

(22) Filed: Dec. 21, 2004

(51) Int. Cl. H04L 9/00; H04K 1/00

(52) U.S. Cl. 713/182

(57) ABSTRACT

Identification display devices and methods for operating the same are provided. The identification display device has a display, and a non-volatile memory having image content depicting a user stored therein. An authentication control system has a user input system that is adapted to sense a user input and an authentication controller, to generate an authentication signal when the user makes an appropriate authentication input. A display controller is adapted to cause the display to present an identifying image only in response to the authentication signal.

### CROSS REFERENCE TO RELATED APPLICATIONS

This application is related to U.S. Ser. No. (Attorney Docket No. 87059 entitled AUTHENTICATION SYSTEM AND METHOD in the name of Telek et al. filed concurrently herewith.

Reference is made to commonly assigned, co-pending patent application U.S. Ser. No. 10/797,683, entitled INTERACTIVE DISPLAY DEVICE, filed Mar. 9, 2004 in the name of Cok.

### FIELD OF THE INVENTION

This invention relates generally identification badges that identify employees and other people who are permitted to access restricted access areas.

### BACKGROUND OF THE INVENTION

Identification badges such as employee identification cards, hospital identification badges, secure identification cards and the like are commonly used in locations such as schools, hospitals, workplaces, sports arenas, government buildings and the like. Typically such identification badges are provided in the form of a card having a user identification image, the name of the user and/or information identifying the issuer of the card. Traditionally, such a badge has been presented to security guards, co-workers and others as indicia that a user is authorized to take certain actions or enter certain areas.

More recently such identification badges have been adapted for use with automatic access control systems. In a typical access control system, the identification badge is used to provide indicia of identity in a machine readable form. Accordingly, identification badges often have some form of identification information in a machine-readable form such as a stripe of a magnetic material having machine readable data encoded thereon. Such machine-readable data is difficult to duplicate and provides a convenient way for an automatic access control system to quickly determine an identity for the user.

Increasingly, such identification badges also incorporate radio frequency identification transponders having data stored therein. The data stored in such radio frequency identification transponders is read by a co-designed transceiver in the access control system that communicates with the transponders by way of radio frequency signals. The use of transponder-equipped badges facilitates the identification process in that identification data can be read automatically using a convenient proximity style reader.

While identification cards of the types described above are difficult to counterfeit and convenient for use with typical access control systems, there still remains a risk that an unauthorized person can obtain the card and attempt to use it to engage in acts that the unauthorized person is not permitted to perform such as entering a restricted area. Conventionally, the presence of the user image is intended to mitigate against such a risk in that people in a restricted area will typically recognize that the person is not authorized in the facility. However, such a situation may exist for an unacceptable period of time before detection. Further, there is a risk that an unauthorized person can use the badge for purposes unrelated the purpose of the badge such as a form of identification for a check or as a form of identification for ordering items or for obtaining content.

Thus, what is needed is an identification badge that is more difficult for unauthorized persons to use or misuse.

### SUMMARY OF THE INVENTION

In one aspect of the invention, an identification display device is provided. The identification display device has a display, and a non-volatile memory having image content depicting a user stored therein. An authentication control system has a user input system that is adapted to sense a user input and an authentication controller, to generate an authentication signal when the user makes an appropriate authentication input. A display controller is adapted to cause the display to present an identifying image only in response to the authentication signal.

In another aspect of the invention, an identification display device is provided. The active identification badge has a display, a non-volatile memory having identification data and a communication circuit adapted to transmit identification data to an authentication control system and to receive an authentication signal from said authentication control system. A display controller is adapted to cause the display to present an identifying image only in response to the authentication signal.

In still another aspect of the invention, a method is provided for operating an identification device having a display. In accordance with the method, a user input is sensed and an authentication signal is generated when the user input corresponds to a stored user input; an identification image is presented when the authentication signal is detected.

### BRIEF DESCRIPTION OF THE DRAWINGS

FIG. 1 is a schematic block diagram of one embodiment of an identification display device of the invention;

FIG. 2 is a flow diagram of one embodiment of a method for operating an identification display device.

FIG. 3 is a flow diagram of another embodiment of a method for operating an identification display device.

FIG. 4 illustrates the use of an embodiment of an identification display device of the invention at a first point in an authentication process.

FIG. 5 illustrates the use of an embodiment of an identification display device of the invention at another point in an authentication process.

FIG. 6 illustrates the use of an embodiment of an identification display device of the invention at still another point in an authentication process.

FIG. 7 illustrates a pattern of the measured signal strength of a signal provided by the identification display;

FIG. 8 shows another embodiment of an identification display device; and

FIG. 9 shows another embodiment of an identification display device.

### DETAILED DESCRIPTION OF THE INVENTION

In accordance with various aspects of the present invention, an identification display device 20 is provided that is suitable for use with an identification badge.

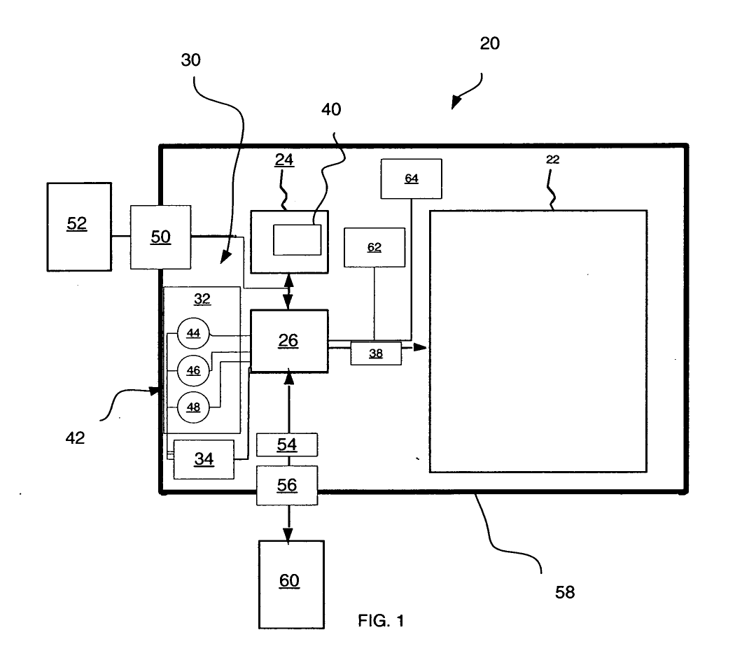

Referring to FIG. 1, one embodiment of an identification display device 20 according to the invention is shown. In this embodiment, identification display 20 has a display 22, a non-volatile memory 24, and a display controller 26 for sending data to and/or receiving data from non-volatile memory 24 and for causing display 22 to present at least one image. An authentication control system 30 has an input system 32 that is adapted to sense a user input and to provide a user input signal to an authentication controller 34 that is adapted to generate an authentication signal when a user input action is made that comprises an appropriate authentication action. Display controller 26 is adapted to cause display 22 to present an identifying image only in response to the authentication signal. In certain embodiments, display controller 26 is further adapted to cause the display to cease presenting the identifying image when the display controller determines that an end of authorization condition exists. Display controller 26 can directly operate display 22 or can provide signals to a display driver 38 that can operate display 22.

Display 22 can take a variety of forms. For example, display 22 can comprise a convention liquid crystal display, an organic light emitting display (OLED), or a polymer light emitting display (PLED).

Examples of such OLEDs and PLEDs are described in the following United States Patents, all of which are incorporated herein by this reference: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

Alternatively, display 22 can comprise a non-volatile bi-stable cholesteric display device. Such a non-volatile cholesteric display 22 provides reflective picture elements that have at least two states and that can be transitioned from one state to at least one other state to form images. Once an image is formed, the image will remain on the display for extended periods of time without the application of additional energy to the display. Thus, such a non-volatile type of display can be used advantageously to provide images on display 22 without requiring that such identification display device 20 provide a power supply with sufficient storage capacity for maintaining the image.

Such a non-volatile cholesteric type display 22 can comprise for example, a reflective passive-matrix display. Such a reflective passive matrix display can be employed advantageously in the present invention because they do not require energy for light emission and are well-suited to low-cost control and manufacturing methods. One such display using bi-stable cholesteric materials is described in U.S. Pat. No. 5,437,811 entitled “Liquid Crystalline Light Modulating Device and Material” issued Aug. 1, 1995. Such displays can be made on flexible substrates and with low-cost roll-to-roll or continuous manufacturing methods thereby reducing cost and providing useful attributes in an interactive display application. In this way, each identification display 20 can be made inexpensively and in a form factor that can be conveniently collected and stored in a manner that is consistent with conventional practices.

Memory 24 can comprise volatile, and non-volatile types of memory and can include multiple components some of which can include volatile read-write memory (e.g. RAM) along with non-volatile memories, such as a read-only memory (e.g. ROM), or a non-volatile read-write memory (e.g. Flash Memory). Such multiple components can comprise separate structures or can be manufactured as an integrated circuit.

In one embodiment, a locking memory 40 is provided for storing an identifying image, a user identification data, and/or authentication data in a manner that makes it difficult to alter such an image or data. In one embodiment, locking memory 40 comprises a conventional non-volatile programmable read-only memory or a write-once memory. In this embodiment, data can be written to the programmable read-only memory or to the write-once memory but, once written, such data cannot be erased, deleted or modified. In this way, the read-only memory provides a reliable record of data stored therein.

In another embodiment, locking memory 40 comprises a non-volatile read-write memory having a memory interface 42 that permits data to be read or written only where appropriate authorizations or codes are supplied to the write-once memory. In this embodiment, data written to locking memory 40 can be associated with identification display device 20 in a manner that cannot be modified without appropriate authorizations.

In still another embodiment, locking memory 40 can comprise a conventional non-volatile read-write memory having data stored therein in an encoded or encrypted fashion that is readable by display controller 26, but that is difficult for a conventional user of identification display device 20 to understand or reprogram properly. Various well-known encoding or encryption schemes can be used for this purpose.

In yet another embodiment, locking memory 40 can also incorporate at least a part of display 22. In this regard, display 22 can be formed at from imaging elements such as patterns of OLED or other light emitting picture elements that are applied to display 22 in an imagewise fashion so that when power is applied to such imaging elements, these imaging elements will only present an image of the user. Optionally, other portions of display 22 can be provided with imaging elements that are applied in a consistent fashion and that are adapted so that a pixellated or segmented image can be presented thereby. Examples of displays or display portions that can be formed in this way include organic light emitting diode displays (OLEDs) and polymer light emitting diode displays (PLEDs) formed for example from materials that are described in any of the U.S. Patents cited above.

Display controller 26 can be a programmable controller such as a microprocessor, microcontroller or programmable analog device. Alternatively display controller 26 can be of a type that is not programmable. In certain embodiments, display controller 26 can include a memory interface and display driver. Such a non-programmable embodiment of display controller 26 can be implemented for example with an application specific integrated circuit, a state machine or hard-wired logic circuit. Such an alternative construction provides a low-cost and low-power display controller 26 that can perform the functions described herein.

In the embodiment of FIG. 1, authentication controller 34 is adapted to sense user input signals generated by one or more input systems 32 of input system 32, such as signals being indicative of a user input action that is made by a user and to generate an authentication signal when the user makes an appropriate authentication action. Authentication controller 34 can take many forms. For example, authentication controller 34 can comprise a conventional signal processor, a programmable logic device, an application specific integrated circuit, a microprocessor, a microcontroller or a combination of discrete electronics. In certain embodiments, display controller 26 and authentication controller 34 can be integrated such as where display controller 26 comprises a programmable microprocessor specially programmed or other form of control circuit that is provided in a fashion that enables that can be adapted to sense the user input signals and to generate an authentication signal.

Input system 32 can take many forms including, but not limited to, user input controls 44, an audio system 46, sensors 48 and/or combinations thereof.

User input controls 44 comprise devices such as electrical switches, transducers or other devices, and associated circuits that receive a user input and provide a user input signal to display controller 26 so that display controller 26 can use the signals in operating identification display device 20. User input controls 44 also provide a user input signal to authentication controller 34 for use in determining whether a user has made an appropriate authentication action. User input controls 44 can comprise, for example, a touch screen input, a touch pad input, a simple switch, a variable control, a 4-way switch, a 5-way switch, a 6-way switch, an 8-way switch, or any other multi-way switch structure, a stylus system, a trackball system, and a joystick system.

Similarly, audio system 46 can be incorporated into identification display device 20 to record audio signals provided by a user. Such recoded audio signals can be provided to authentication controller 34 so that authentication controller 34 can make an authentication determination. A wide variety of efficient, low cost, audio capture methods and circuits are well-known and enabling devices are commercially available. Optionally, an audio system 46 can be further adapted to convert audio signals into an audible form.

Sensors 48 can include light sensors, position sensors, orientation sensors, accelerometers, image capture systems, biometric sensors such as fingerprint scanners or retinal scanners, and other sensors known in the art that can be used to detect conditions in the environment surrounding identification display device 20 and/or conditions relevant to a user of the identification display device 20 and to convert this information into a user input signal that can be used by display controller 26 in governing operation of identification display device 20 and/or authentication controller 34 in making authentication determinations.

Various optional circuits and systems that can usefully be incorporated in an identification display device 20 are also shown in FIG. 1. In particular, an external interface 50 is optionally provided. In the embodiment shown in FIG. 1, external interface 50 is accessible to external circuitry 52. When external interface 50 is connected to external circuitry 52, for example, by way of a Universal Serial Bus connector, external interface 50 can be used to transmit and receive image content and identification data from external circuitry 52 and to store this image content or other data in non-volatile memory 24. Alternative embodiments of external interface 50 can be provided, for example, by a networked interface to a computer network or the Internet. External interface 50 can be used to set up and program non-volatile memory 24, display controller 26 and/or authentication controller 34 with an identification image and other information including, but not limited to, authentication data, identification data and/or programming instructions.

An optional communication circuit 54 is provided for enabling communication between identification display device 20 and an external device such as an access control system 60. Communication circuit 54 can take a variety of forms, for example it can comprise any of a transmitter, receiver, transceiver, transcoder, or any other device adapted to encode and decode data for exchange during communication with other devices such as external circuitry 52 or with an access control system. Where appropriate, a communication access port 56 can be provided to facilitate such communication that provides access to areas outside of a body 58 of identification display device 20.

Communication circuit 54 can be implemented in a variety of ways. In one embodiment, communication circuit 54 can comprise a wireless communication circuit that uses radio frequency, optical or other known wireless communication circuits and systems to establish a wireless communication path with, for example, access control system 60. Examples of such wireless communication systems include, but are not limited, to circuits and systems that communicate in ways that that conform to wireless communication standards such as the so-called “Wi-Fi” and so-called “Bluetooth” standards established and described at Institute of Electrical and Electronic Engineers standards 802.11a and 802.11b. Alternatively communication circuit 54 can be adapted to communicate using infrared technology using protocols established by the infrared data association (IrDA). Such protocols include, but are not limited to the serial infrared protocol (SIR) and other protocols developed by the IrDA. Communication circuit 54 can also be adapted to communicate with radio frequency transmitters and receivers that are adapted to exchange data with passive or active radio frequency transponders of the type that are often found in access control systems 60.

In such wireless embodiments, access port 56 provides, for example, an antenna for use in radio frequency communication, or light transmitting and sensing areas adapted to optically exchange data, such as an infrared or other optical interface system known in the art.

In other embodiments, communication circuit 54 can be adapted for communication with another device using a direct electrical, magnetic or optical path between access port 56 and an access control system 60. In such embodiments access port 56 can comprise, for example, a serial or parallel port, or a networked interface to a computer network or the Internet or a magnetic stripe. One example embodiment of a communication circuit of this type is a communication circuit 54 that is adapted to enable communication using hardware and protocols that are consistent with the EIA/TIA-232-E standard entitled “Interface Between Data Terminal Equipment and Data Circuit-Termination Equipment Employing Serial Binary Data Interchange” prepared by the Electronic Industry Association and the Telecommunications Industry Association. Other example embodiments of a communication circuit 54 of this type include circuits and systems that conform to the standards set for the universal serial bus standard, and the IEEE 1394 (so-called “Firewire”) standard. Communication circuit 54 can also comprise circuits and systems that comply with other standards or that comply with proprietary standards. Communication circuit 54 can be adapted to communicate with magnetic stripe readers and the like using appropriate transducers, and/or other appropriate circuitry.

In still another embodiment, communication circuit 54 can optionally be adapted to exchange data with a portable memory device such as a removable memory card that can be held by access port 56 of identification display device 20 and moved to an access port 56 of another interactive display device so that data can be exchanged using the removable memory card as an intermediary.

In yet another alternative embodiment, a direct link between display controller 26, authentication controller 34 and an external device, such as access control system 60, can be established without the use of communication circuit 54 by using optional external interface 50, as described above.

An optional power switch 62 is provided to activate or deactivate the identification display device 20.

In the embodiment shown in FIG. 1, identification display device 20 comprises a power cell 64, for example a battery, that provides power to display 22, non-volatile memory 24, display controller 26, display driver 38, authentication system 30, memory interface 42, and/or external interface 50, and communication circuit 54. In certain situations, power can be supplied to these components of identification display device 20 by way of external interface 50 and/or access port 56.

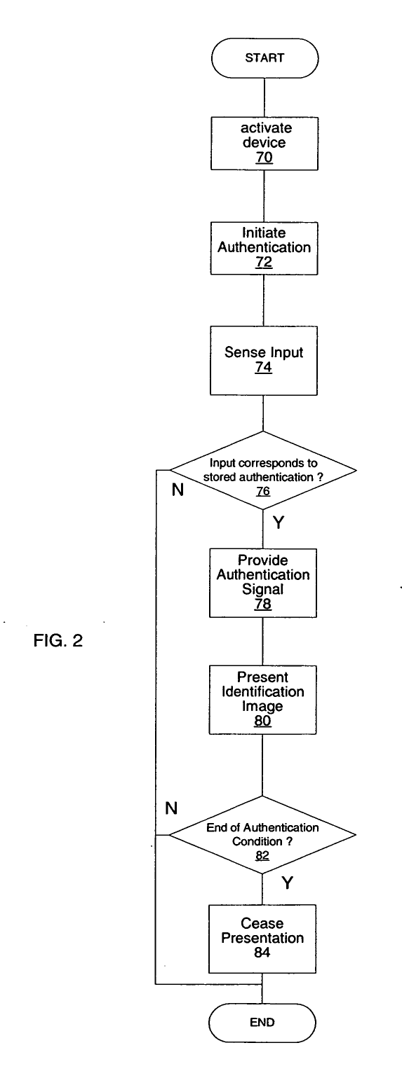

FIG. 2 shows a flow diagram depicting one embodiment of a method for operating identification display device 20. In this embodiment, identification display device 20 is activated (step 70) and an authentication process is initiated (step 72). Identification display device can be activated in any number of ways. In one embodiment, identification display device time is activated when a user triggers switch 62 to provide power to identification display device. Alternatively, in circumstances where identification display device 20 has a user input control 44 actuation of selected portions of user input control 44 can also activate identification display device 20. In still other embodiments of the invention, communication circuit 54 and/or sensors 48 can be adapted to detect communication signals or other conditions external to identification display device 20 that indicate that an identification display is needed. For example, a wireless signal broadcast by a hospital, library, or workplace, can be sensed that causes identification display device 20 to activate. In this way such identification that can be activated automatically as a user approaches an area in which identification display device 20 is required. Conversely, identification display device 20 can be adapted so that it is stored for example in a docking station (not shown) during periods of non-use and activated automatically when removed from the docking station.

Any embodiment shown, an authentication process is initiated automatically upon activation. However, in other embodiments, the authentication process (step 72) can be initiated only upon demand or request by user of identification display device 20, such a demand or request can be made, for example, using input system 32.

During the authentication process, a user is provided with an opportunity to make some authentication input to verify that the user is authorized to use the identification display device 20 and this action is sensed (step 74). In one embodiment of the invention, the user actuates a user input control 44 to enter passwords, pass codes, text data graphics symbols drawings markings and the like. In another embodiment, the user can provide audio passwords such as a spoken word or other sound that is detectable by audio system 46. In still another embodiment, a user can take some other action that can be sensed by sensors 48. For example, a user can vary the position, orientation, or configuration of identification display device 20, or perform some other act that can be sensed by an accelerometer position sensing system. In another example, a user can position identification display device 20 so that sensors 48, such as image capture systems, and biometric sensors, such as fingerprint scanners or retinal scanners, can scan the user to obtain biometric data.

Input system 32 provides a user input signal to authentication controller 34 based upon the user input signals. Authentication controller 34 compares the user input signal to authentication data that is stored in non-volatile memory 24 (step 76). Where the user input signal corresponds to stored authentication data, authentication controller 34 provides an authentication signal to display controller 26 (step 78). In response to the authentication signal, display controller 26 causes display 22 to present an identification image (step 80).

Display controller 26 is further adapted to determine when an end of authentication exists (step 82) and to cease presentation when the end of authentication condition is determined (step 84).

Display controller 26 is further adapted to determine that an end of authorization condition exists (step 80) and to cause display 22 to cease presenting the identifying image when display controller 26 (step 82) when such a determination is made (step 82). There are a variety of ways in which display controller 26 can determine that an end of authentication condition exists. In a simple embodiment, each authentication is active only for a period of time and the authentication simply expires at the end of that period of time. In another embodiment of the invention, sensors 48 can be adapted to sense when the identification display device 20 is separated from a user or is held by another person. For example, sensors 48 can be adapted to sense identification display device 20 is worn on a lanyard or holster proximate to the body of a user such as by sensing body temperature of the user. Where sensor 48 senses temperature below that of the body temperature of the user, an end of authorization condition can be determined. In an example such as the one described above wherein identification display device 20 is activated by a radio frequency signal, the absence of such a signal can be detected by communication circuit 54 and an end of authentication signal can be transmitted to device controller 26 by communication circuit 54. Such an arrangement is useful in that it provides an identification display device 20 that displays identification information only while the identification display device 20 is located in an area in which it will be used for intended purposes.

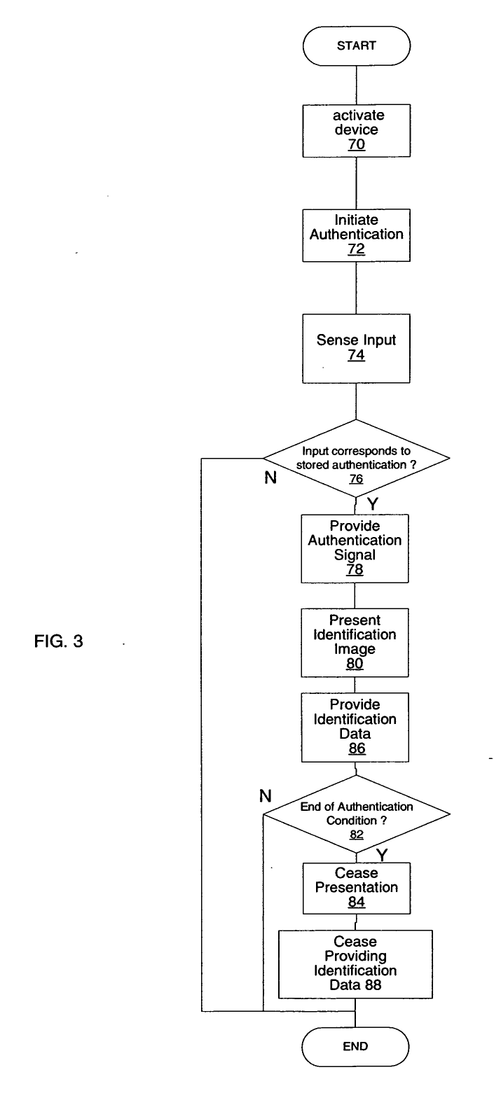

As noted above, identification display devices 20 are typically used in environments wherein they provide identification data to an access control system. In one embodiment of the invention, shown in FIG. 3, the identification display device 20 has a display controller 26 that is adapted so that it will cause display controller 26 to provide identification data in a form that is usable by such a system only after an authentication signal has been provided to display controller 26 (step 86) and to continue to provide this identifying information only until an end of authentication signal (step 88) is received. It will be appreciated that such an embodiment of the invention enables a conventional access system that is based on identification cards to provide the additional level of security provided by an authentication process without retrofitting an access control system that relies solely upon identification data to control access.

In yet another alternative embodiment of the invention authentication controller 34 is adapted to use signals from an access control system during the authentication process (step 72).

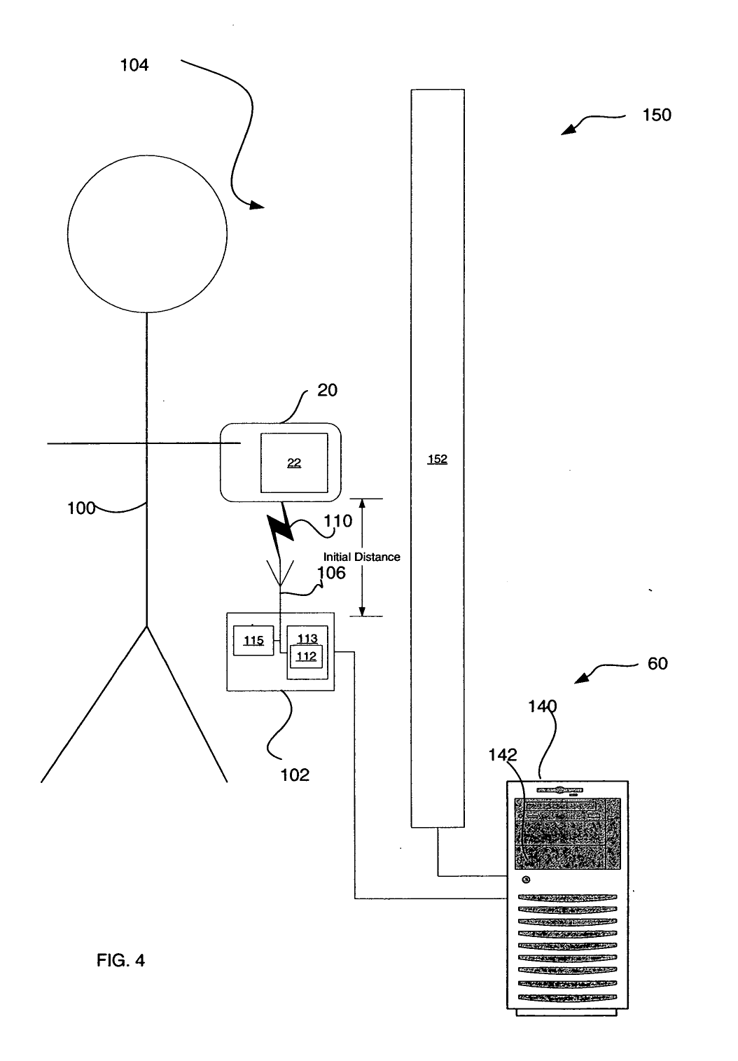

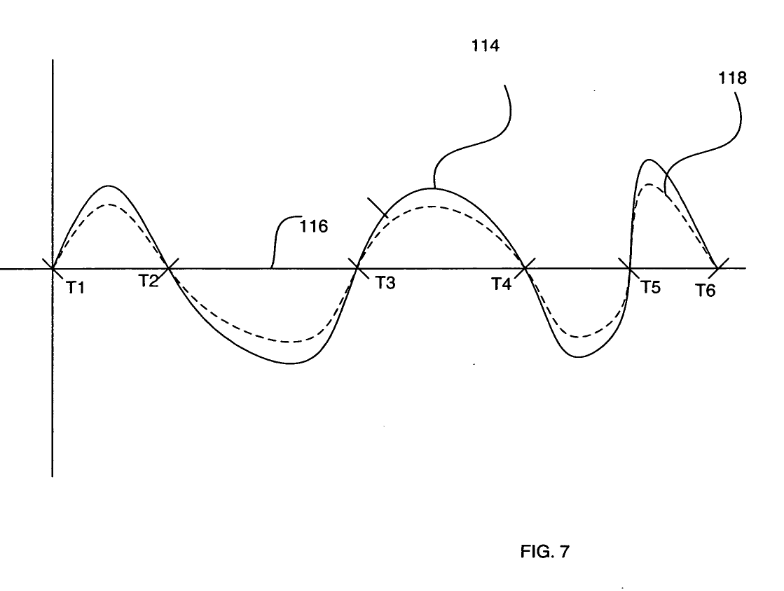

One example of this is shown in FIG. 4, wherein a user 100 holds an identification display device 20 at an initial distance from an antenna 106 of a reader device 102 at an access control point 104 in an access control system 60, during an initial portion of an authentication process. While identification display device 20 is positioned at the initial distance, communication circuit 54 radiates a signal 110 that can be detected by signal strength monitoring circuit 112 associated with a receiver circuit 113 in reader device 102. Signal strength monitoring circuit 112 and determines initial signal strength of signal 110. This occurs at time T1 in FIG. 7 which illustrates a pattern 114 of the measured signal strength of the signal 110 radiated by identification display device 20 over an authentication time period (the time period between T1 and T6) as compared to a baseline 116 that is determined based upon the initial signal strength.

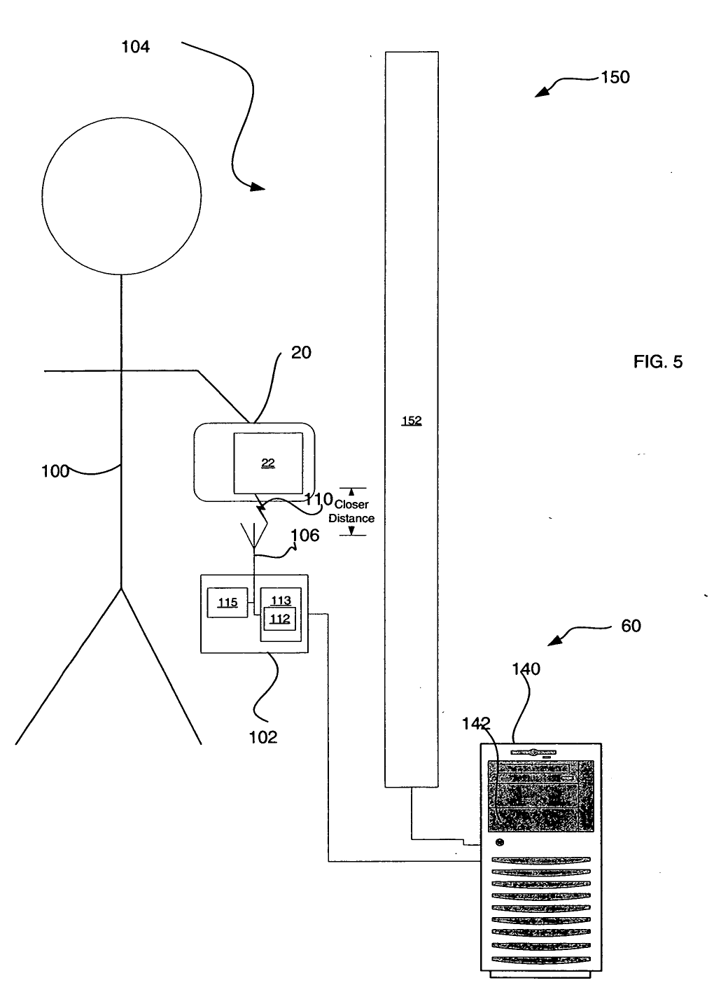

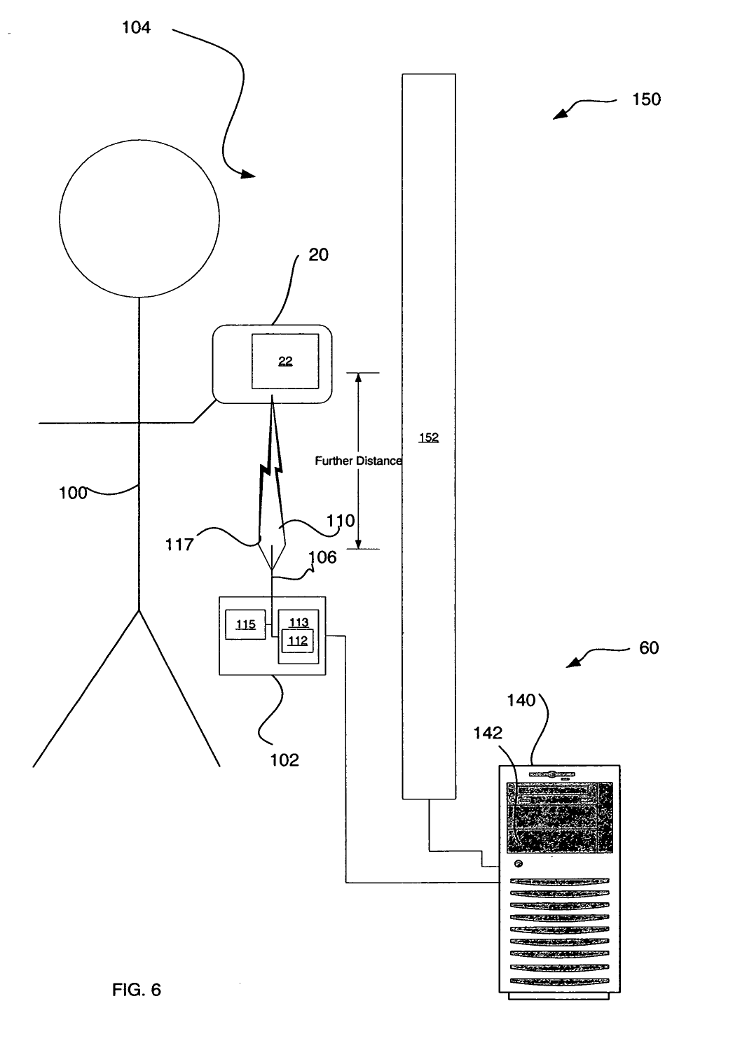

As shown in FIGS. 5 and 7, at times T1-T2, T3-T4 and T5-T6, user 100 has positioned identification display device 20 at positions that are closer to antenna 106 than the initial position. Therefore, signal strength monitoring circuit 112 detects signal strength in excess of the baseline 116. This is because the sensed intensity of broadcast radio frequency signals increases in proportion to the square of the distance from the source to a sensor thus, as identification display device 20 is moved closer to an antenna 106 of reader device 102, strength of wireless signal 136 that is detected by signal strength monitoring circuit 112 increases. Conversely, as shown in FIGS. 6 and 7, at times T2-T3, and T4-T5 user 100 has positioned identification display device 20 at positions that are further from antenna 106 than the initial position. Therefore, for the reasons described above, signal strength monitoring circuit 112 detects a signal strength that is less than that of the baseline 116. Signal strength monitoring circuit 112 causes a reader transmitter 115 to transmit an input signal 117 to communication circuit 54 that is indicative of the pattern 114 of user input actions evidenced by the change in signal strength.

In the embodiment of FIG. 5-7, display controller 26 is adapted to perform the function of an authentication controller in that display controller authenticates the identity of user 100 by obtaining at least one comparison pattern 118 representing authentication movements that have been obtained from user 100 at a previous time and stored, for example, in non-volatile memory 24. Display controller 26 compares pattern 114 of signal strength data obtained during authentication to comparison pattern 118 to determine whether the patterns are consistent or inconsistent. A wide variety of waveform matching algorithms are known in the electrical engineering and sound sampling arts that can be applied for this purpose. In one simple example, display controller 26 can examine pattern 114 to determine the number of transitions from a far position to a close position and the relative proportion of time between transitions. The number of transitions, proportional separation of the transitions, the proportional separation or other aspects of the overall pattern 114 can then be compared to the number of transitions or the proportional separation of the transitions or other aspects of comparison pattern 118. In another embodiment, a range of acceptable variation about comparison pattern 118 can be defined, and so long as pattern 114 is within this range display controller 26 can determine that a correspondence exists.

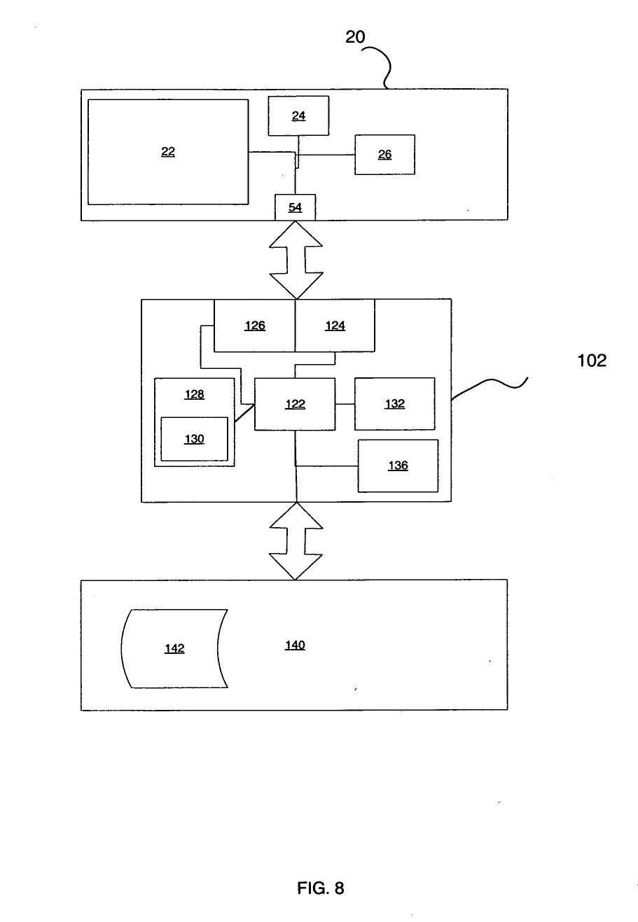

FIG. 8 shows another embodiment of the invention, wherein an identification display device 20 comprises a display 22, non-volatile memory 24, display controller 26 and communication circuit 54. In this embodiment, non-volatile memory 24 has identification data stored therein and communication circuit 54 is adapted to transmit identification data to an external device such as reader device 102. In this embodiment, when user 100 presents identification display device 20 to reader device 102, a controller 122 causes a transmitter 124 to transmit a signal to obtain identification data form identification display device 20.

Communication circuit 54 senses the signal from transmitter 124 and transmits a responsive signal bearing the identification data. A receiver 124 receives the responsive signal and provides it to controller 122. Reader controller 122 then initiates an authentication process wherein reader device 102 senses a user input action by the user. Reader device 102 can sense the user input action by way of a reader device input system 128 having controls 130 operable by a user, an audio system (not shown) adapted to convert sounds made by a user into a user input signal, or other sensors (not shown) such as those described above and that can be used to sense physical characteristics of the user, or environmental conditions from which a user input can be sensed. In the embodiment illustrated, controller 122 is adapted to transmit data representing the user input along with user identification data to a remote database device 140. Remote database device 140 obtains authentication data from a storage device 142 using the user identification data, compares the user input action data to the stored authentication data, and, where a correspondence is found therebetween remote database device 230 transmits an authentication signal to reader device 102. Reader controller 122 causes reader transmitter 124 to transmit the authentication signal to communication circuit 54. Communication circuit 54 transmits the authorization signal to display controller 26 which causes display controller 26 to cause an identification image to be presented on display 20. The authentication signal can comprise an identification image which can be prestored in remote database device 140. Optionally an image capture system 136 can be provided in reader device 102 so that a current image of the authenticated user can be captured and provided an authentication image on display 22. The authentication signal can also comprise any other type of signal that causes display controller 26 to cause an identification image to be presented on display 22.

In another embodiment of this type reader device 102 can have a reader controller 122 that is adapted to receive the user input action and to determine whether the action corresponds to stored authentication data associated with the user. Data associating the user with stored authentication data can be obtained by reader controller 122 from a remote database such as remote database device 140, or from a local memory 138 in the reader device 102. In one embodiment, such authentication data is stored in a locking memory 40 of identification display device 20.

In this embodiment display controller is further adapted to cause the display to cease presenting the identifying image when the display controller determines that an end of authorization condition exists. In an access control system 60 of the one illustrated in FIGS. 4-7, it is often the case that users are required to present identification upon entering and upon exiting an area 50 protected by a barrier 152 controlled by access control system 60. In this embodiment, when communication circuit 54 provides an identification signal to a reader device 102 that is positioned at an exit of a restricted access area or other domain protected by an access control system, reader device 102 can provide a signal to communication circuit 54 that is adapted to indicate that the facility is being exited. This can act as an end of authentication signal that causes display controller 26 to end the presentation of the displayed image. In another embodiment of the invention, a reader device 102 can provide a signal that is not inherently differentiable from a signal at an entry point, however, communication circuit 54 and display controller 26 can cooperate to determine, based upon circumstances such as a time of day, a location of the signal, and other factors that an end of authentication condition exists so that display of the identification image can be suspended.

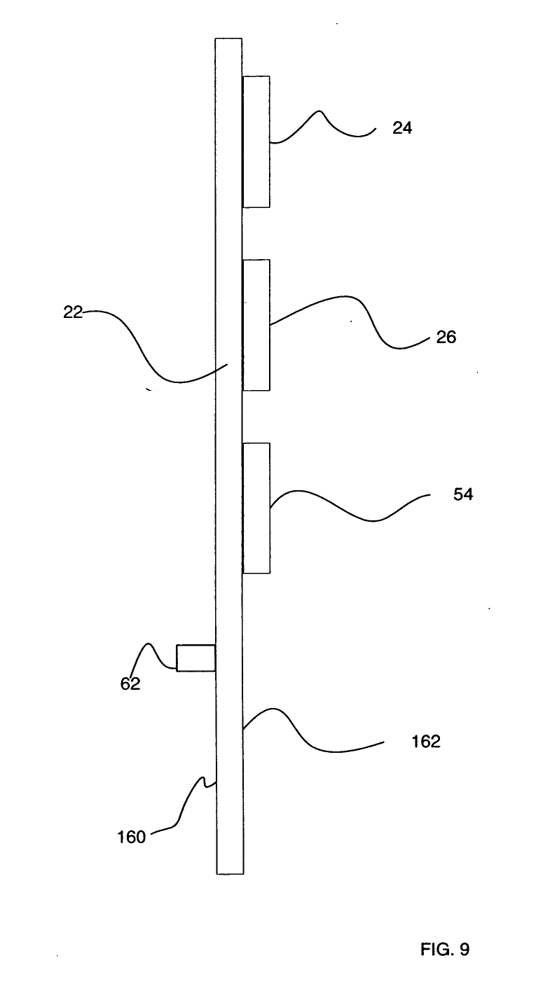

It will be appreciated that it is useful to minimize the thickness of identification display device 20 to mimic, as closely as possible, conventional identification tokens for example, cards, photographic prints, paper media and the like. To this end, the components such as non-volatile memory 12, display controller 26, and switch 60 that are used in various embodiments of identification display device 20 can be assembled on a back 162 or face 160 of a display 22 as shown in the embodiment shown in FIG. 9. In particular, it may be useful to have non-volatile memory 24, display controller 26 and communication circuit 54 affixed to the back of display 22 and power switch 62 affixed to a face 160 of display 22 or otherwise positioned so that it can be conveniently actuated by a user of identification display device 20. In this way, identification display device 20 can take a form that is consistent with the form of a conventional identity badges, cards and the like. Identification display device 20 can also be incorporated onto rigid or flexible and/or foldable substrates to provide a wide variety of items.

In certain embodiments, display controller 26 and non-volatile memory 24 can be combined into a single integrated circuit and/or potted together, for example, using a protective resin to provide a small, low-cost circuit. Any protective material applied to the circuitry can be applied after the image content and interaction data is written to non-volatile memory 24.

In operation, a full range of information can be written into the non-volatile memory 12 before assembly of identification display device 20 or afterward. Alternatively, a purchaser of identification display device 20 can personalize the image content and/or interaction data, for example by transmitting personalization data through the external interface 50, or communication circuit 54. Such personalization data can include, for example, information identifying the issuer of the identification device, and corporate logos, return if found information, audio, and video signals.

It will be appreciated that the identifying image can comprise a digital image such as a digital still image, a sequence of digital still images, a video clip, text, graphics, symbols, steganographically encoded information and/or any other form of information that can be presented using display 22.

The invention has been described in detail with particular reference to certain preferred embodiments thereof, but it will be understood that variations and modifications can be effected within the spirit and scope of the invention.

### Parts List

20 identification display device
22 display
24 non-volatile memory
26 display controller
30 authentication control system
32 input system
34 authentication controller
38 display driver
40 locking memory
42 memory interface
44 user input control
46 audio system
48 sensors
50 external interface
52 external circuitry
54 communication circuit
56 access port
58 body
60 access control system
62 power switch
64 power cell
70 activate device step
72 initiate authentication step
74 detect user input action
76 compare step
78 generate authentication signal step
80 present identification image step
82 determine end of authentication step
84 cease presentation of identification image step
100 user
102 reader device
104 access control point
106 antenna
110 signal
112 signal strength monitoring circuit
113 receiver circuit
114 pattern
115 reader transmitter
116 baseline
117 input signal
118 comparison pattern
122 reader controller
124 reader transmitter
126 receiver
128 input system
130 controls
136 image capture system
138 local memory
140 remote database device
142 storage device
150 area
152 barrier
160 face
162 back

1. An identification display device comprising:
a display;
a non-volatile memory having image content depicting a user stored therein;
an authentication control system having a user input system adapted to sense a user input action that is made by a bearer of the identification badge and an authentication controller to generate an authentication signal when the user input system senses that a holder of the identification badge has made an appropriate authentication action; and
a display controller adapted to cause the display to present an identifying image only in response to the authentication signal.

2. The identification display device of claim 1, wherein said display controller is further adapted to cause the display to cease presenting the identifying image when the display controller determines that an end of authorization condition exists.

3. The identification display device of claim 2, wherein the end of authorization condition comprises the elapse of a period of time from the time of the authentication signal, a fixed time and a relative amount of time as measured from some other event.

4. The identification display device of claim 2, further comprising a communication circuit adapted to sense at least one signal and to generate an end of authentication signal based thereupon.

5. The identification display device of claim 2, wherein said identification image comprises at least one of text, graphics, symbols, a still image.

6. The identification display device of claim 1, wherein the non-volatile memory comprises at least one of a read only semiconductor memory, a write once semiconductor memory and a display on to which image forming elements are recorded in an imagewise fashion representing the identification image.

7. An identification display device comprising:
a display;
a non-volatile memory having identification data;
a communication circuit adapted to transmit identification data to an external device having a user input adapted to sense a user input and to receive a signal from said external device based upon the user input; and
a display controller adapted to use the signal from the external device to determine when to cause the display to present an identification image so that an identifying image is presented only when a user had made a user input that corresponds to a stored user input.

8. The identification display device of claim 7, wherein said display controller is further adapted to cause the display to cease presenting the identification image when the display controller determines that an end of authorization condition exists.

9. The identification display device of claim 7, wherein said external device is adapted to determine when a user input is made that corresponds to a stored user input and to provide an authorization signal to the display.

10. The identification display device of claim 9, wherein the external device provides the identification image.

11. The identification display device of claim 7, wherein the external device provides a user input signal.

12. The identification display device of claim 9, wherein said identification data is stored in a locking memory.

13. A method is provided for operating an identification device having a display, the method comprising:
sensing a user input;
generating an authentication signal when the user input corresponds to a stored user input; and
presenting an identification image when the authentication signal is detected.

14. The method of claim 13, further comprising the steps of:
a non-authentication condition; and
presentation of the identification image is suspended in response to the detected non-authentication condition.
